(19) United States
(12) Patent Application Publication
(10) Pub. No.: US 2024/0061669 A1
(43) Pub. Date: Feb. 22, 2024

(54) Managing Updates for an Artificial Reality System in Cross-Version and Cross-Platform Environments

(71) Applicant: Meta Platforms Technologies, LLC, Menlo Park, CA (US)

(72) Inventors: Robert Blake TAYLOR, Los Angeles, CA (US); Cameron DUNN, Playa Vista, CA (US); Oludare Victor OBASANJO, Renton, WA (US)

(21) Appl. No.: 17/820,595

(22) Filed: Aug. 18, 2022

(51) Int. Cl. G06F 8/65; G06F 3/01; G06F 8/71

(52) U.S. Cl. CPC G06F 8/65; G06F 3/011; G06F 8/71

(57) ABSTRACT

Conventionally, applications are updated to the current version and the previous version is removed, eliminating backward compatibility. The disclosed technology provides XR runtimes that can dynamically execute a runtime version due to the runtimes being executed as a collection of selectable data bundles. Thus, implementations can ship multiple versions of an XR runtime to allow old versions of the XR runtime to remain when updates occur. Implementations can maintain backward compatibility and allow old experiences to run in an application. Implementations can access metadata associated with an experience to determine what runtime version (or set of runtime versions) under which the experience can execute, and can dynamically run the latest runtime version that can support that experience. When multiple users in a group are joining an experience, implementations can select and run a common server-supported runtime and push any necessary data bundles for the experience to the client devices.

### TECHNICAL FIELD

The present disclosure is directed to managing updates for an artificial reality system in cross-version and cross-platform environments.

### BACKGROUND

Backward compatibility is important to preserve access to older software versions having features that users may still want to experience. Conventionally, applications are updated to the current version, removing or replacing portions of the previous version, which eliminates access to retired features. In addition, updated applications often become compatible only with the newest version of a runtime platform, entirely eliminating access to older software versions supported by previous versions of the runtime platform.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for managing application updates in cross-version and cross-platform environments.

FIG. 6 is a block diagram illustrating a system used in some implementations of the present technology for managing updates for an artificial reality system in cross-version and cross-platform environments.

FIG. 7A is a conceptual diagram illustrating an exemplary system used in some implementations for selecting the latest supported version of a runtime for an artificial reality experience.

FIG. 7B is a conceptual diagram illustrating an exemplary system used in some implementations for selecting the latest version of a runtime that is backward compatible with a supported version of a runtime for an artificial reality experience.

FIG. 8 is a conceptual diagram illustrating an exemplary system used in some implementations for selecting the latest supported overlapping version of a runtime in a multiplayer artificial reality experience.

FIG. 9 is a conceptual diagram illustrating an exemplary system used in some implementations for selecting and pushing the latest supported version of a runtime in a multiplayer artificial reality experience.

FIG. 10 is a conceptual diagram illustrating an exemplary system used in some implementations for selecting and depreciating unused versions of a runtime.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to managing updates for an artificial reality (XR) system in cross-version and cross-platform environments. Conventionally, applications are updated to the current version and the previous version is removed, eliminating backward compatibility. The disclosed technology can ship multiple versions of a runtime to allow old versions of the runtime to remain when updates occur. Thus, implementations can maintain backward compatibility and allow old experiences to run in an application until they're explicitly retired.

As used herein, a runtime can include code to retrieve and execute data bundles associated with XR experiences in an application, and in some implementations, can be supported by hardware and/or interface with operating systems. The runtime can have core functionality useable to identify and select the data bundles that support the features of the various XR experiences, including application programming interfaces (APIs), scripts, and assets. The APIs, scripts, and assets can define objects, actions, environments, and/or interactions associated with an XR experience. As appreciated by one skilled in the art, APIs can be interfaces or available functions, that an application can call, paired with a defined result. Scripts can be lists of commands for a runtime that automate processes to be performed by an application. Assets can be virtual representations (e.g., objects, locations, user data, UI elements, etc.) used by an application when executed on a particular runtime version.

Some implementations can automatically select a runtime that supports the identified features of an XR experience, while some implementations can select a latest available version of a runtime corresponding to the set of runtimes that the XR experience has specified. Some implementations can access metadata associated with an XR experience to determine what runtime version (or set of runtime versions) under which the XR experience can execute, and can dynamically run the XR experience with the latest compatible runtime version. For example, an XR experience of a virtual party can have metadata indicating that it is compatible with runtime versions 1.12, 1.13, and 1.15, while an XR system has available runtime versions 1.0 through 1.19. In this example, implementations can execute the virtual party on the XR system with runtime version 1.15, because it is the latest available runtime version specified as being compatible with the XR experience.

Some implementations can select a later available version of a runtime, even if it is not specified as being compatible with the XR experience, if it is backward compatible with an earlier runtime version specified by the XR experience. In the same example of a virtual party, implementations can determine that runtime version 1.17 is backward compatible with runtime version 1.15. Thus, in this example, implementations can execute the virtual party with runtime version 1.17, because it is the latest available version of the runtime that is backward compatible with a specified runtime version, i.e., runtime version 1.15.

Implementations can also be used in multi-player XR experiences in which not every player's XR system has the same available runtime versions. Some implementations can determine which runtime versions the XR systems have available, as well as which runtime versions are compatible with the XR experience. Some implementations can execute the XR experience with the latest runtime version that is both available on all of the XR systems and that is compatible with the XR experience. For example, an XR experience of a virtual bowling game can have metadata indicating that it is compatible with runtime versions 1.1 to 1.7. Player 1's XR system can have runtime versions 1.3 and 1.6 to 1.9 installed, while Player 2's XR system can have runtime versions 1.1 to 1.6 and 1.9 installed. Implementations can determine that Player 1 and Player 2 have overlapping runtime versions 1.3, 1.6, and 1.9, and of those, runtime versions 1.3 and 1.6 are compatible with the virtual bowling game. Thus, implementations can execute the virtual bowling game with runtime version 1.6, because it is the latest available runtime version that is compatible with the XR experience and that is available on both Player 1 and Player 2's XR systems. In another example, implementations can execute the virtual bowling game with runtime version 1.9, which is available on both Player 1 and Player 2's XR systems, if runtime version 1.9 is backward compatible with at least one of compatible runtime versions 1.1 to 1.7.

Some implementations can determine which runtime versions the XR systems have available and which runtime versions are compatible with the XR experience, and can push the latest compatible runtime version to XR systems that do not have it available. Some implementations can determine the latest compatible runtime version that is available on at least some, if not most, of the XR systems, and can push the latest compatible runtime version to XR systems that do not have it available. In the above virtual bowling game example, implementations can instead determine that Player 1's XR system has access to the latest compatible runtime version 1.7, while Player 2's XR system does not. Thus, implementations can push runtime version 1.7 to Player 2's XR system, and execute the virtual bowling game with runtime version 1.7.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

The implementations disclosed herein can be particularly useful in XR systems because of the large number of experiences available and the desire to maintain access to older experiences across platforms. Because application and runtime updates can be frequent, user access to older experiences would otherwise be lost when one or the other is updated. The disclosed implementations provide specific technological improvements over existing systems in that they allow for backward compatibility of a plurality of versions of applications on a computing system, seamlessly improving an XR system's ability to execute a variety of applications not possible with conventional systems. Further, some implementations can phase out and uninstall versions of a runtime that become unused over time, freeing up storage for newer versions as they become available, while still allowing access to older experiences that are still being used.

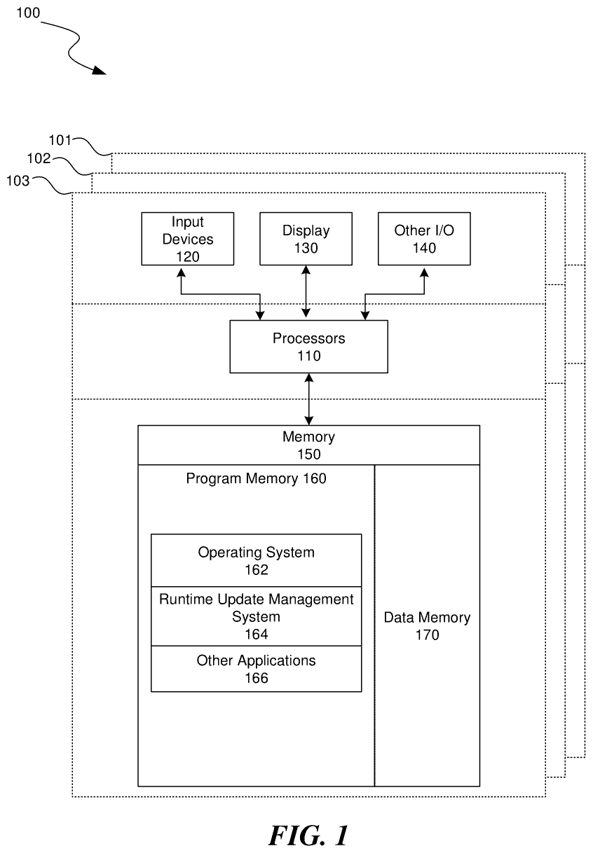

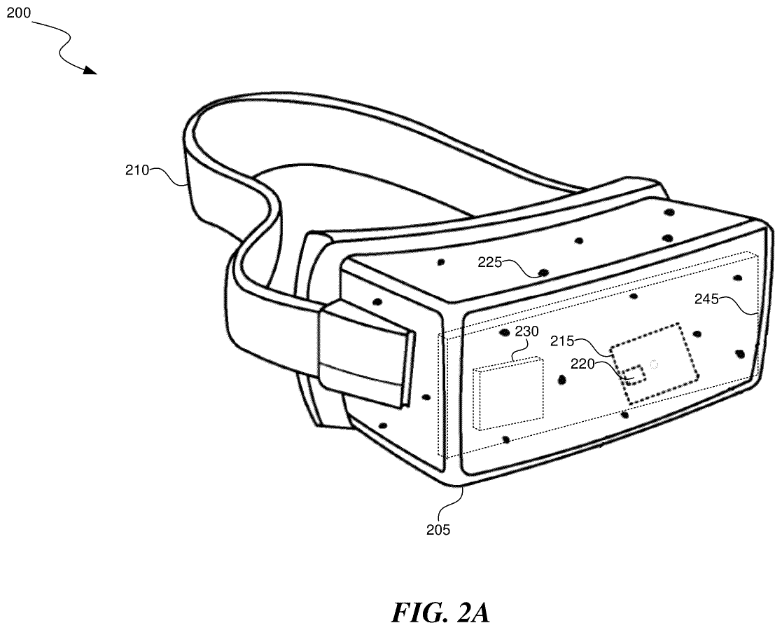

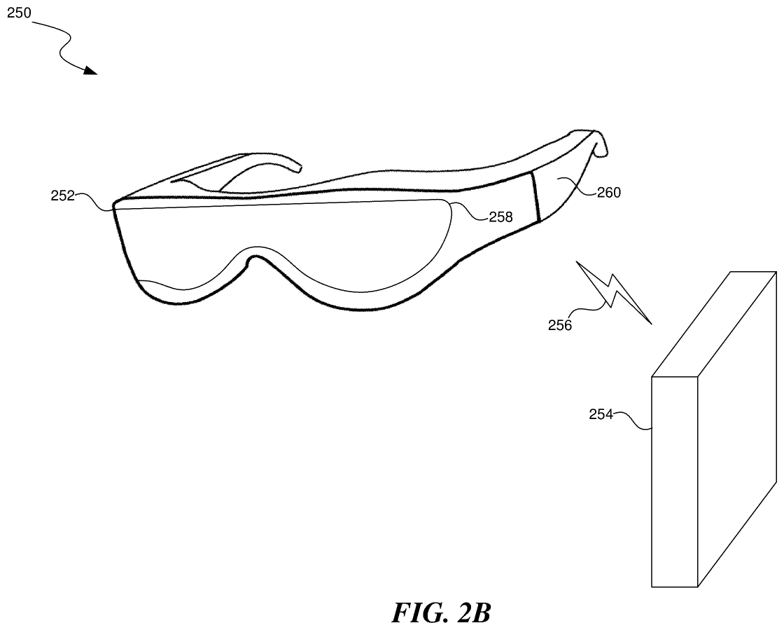

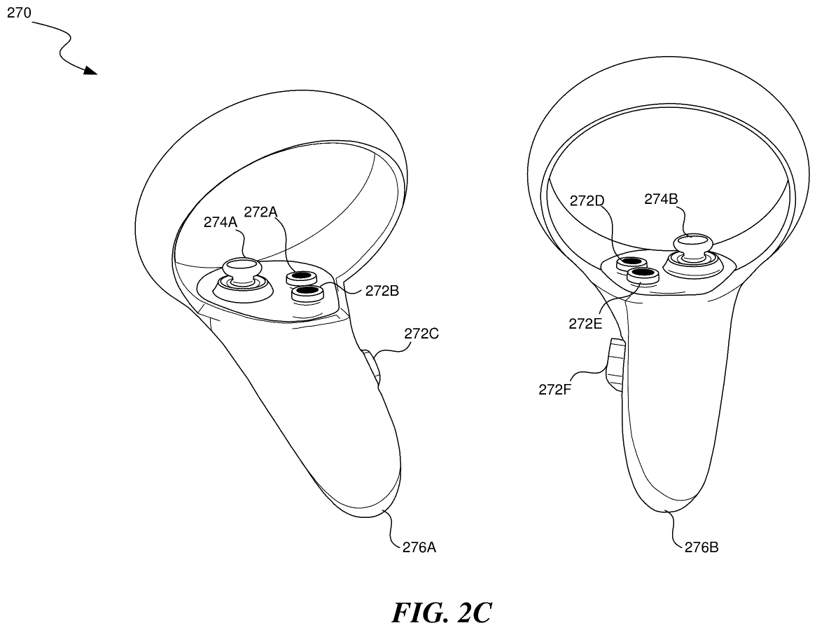

Several implementations are discussed below in more detail in reference to the figures. FIG. 1 is a block diagram illustrating an overview of devices on which some implementations of the disclosed technology can operate. The devices can comprise hardware components of a computing system 100 that manage updates for an artificial reality (XR) system in cross-version and cross-platform environments. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, runtime update management system 164, and other application programs 166. Memory 150 can also include data memory 170 that can include, e.g., runtime versions, data bundles including scripts and assets, metadata associated with XR experiences, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

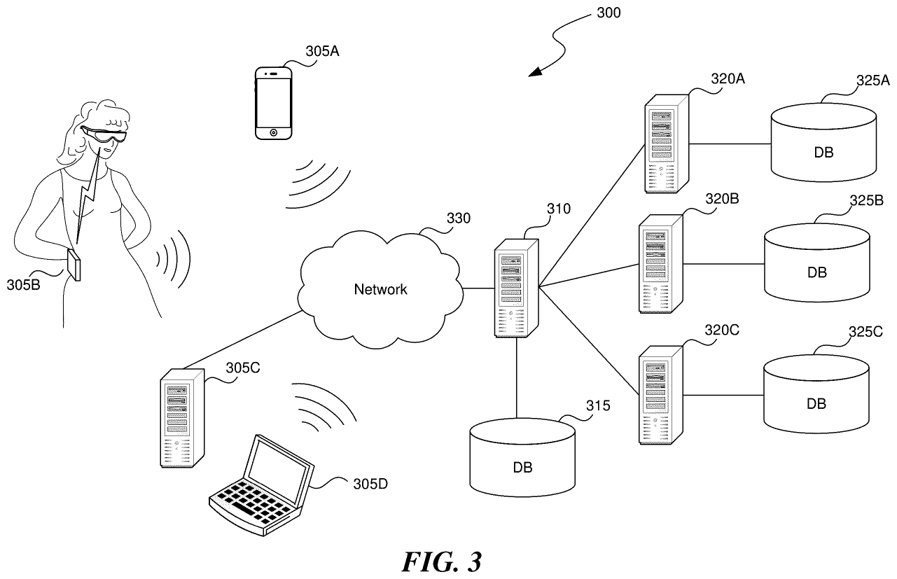

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

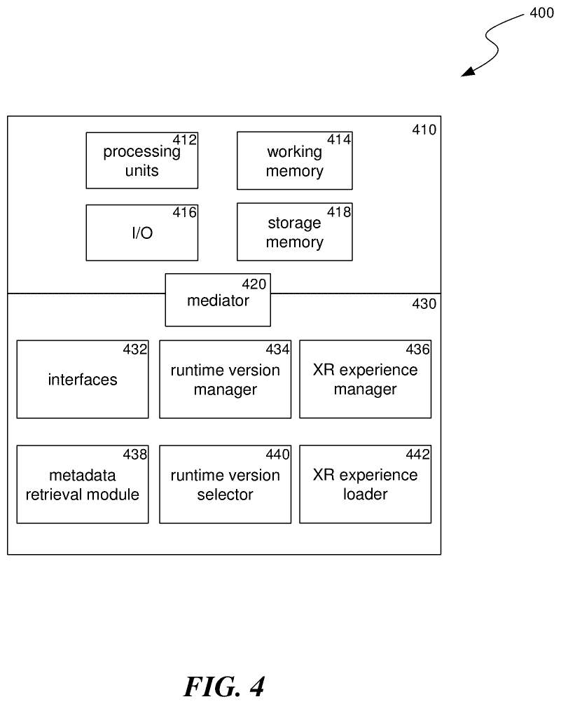

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for managing updates for an artificial reality (XR) system in cross-version and cross-platform environments. Specialized components 430 can include runtime version manager 434, XR experience manager 436, metadata retrieval module 438, runtime version selector 440, XR experience loader 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

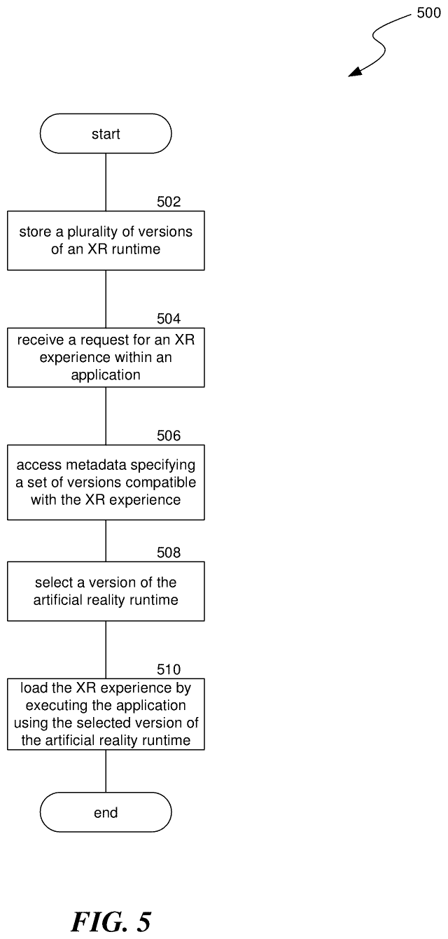

Runtime version manager 434 can manage a plurality of versions of an XR runtime stored in storage memory 418. As appreciated by one skilled in the art, an XR runtime can be the environment in which an application is executed that provides the functionality needed for the application. Each version of the XR runtime can specify a set of data bundles including APIs, scripts, and assets that will be used when that version of the XR runtime is executed. When a version of the XR runtime is executed, runtime version manager 434 can dynamically select and load the set of data bundles needed to execute an XR experience, which, in some implementations, can be partially or wholly used by multiple runtime versions. As appreciated by one skilled in the art, APIs can be interfaces or available functions, that an application can call, paired with a defined result. Scripts can be lists of commands for a runtime that automate processes to be performed by an application. Assets can be virtual representations, such as objects (e.g., user avatars, trees, cars, etc.), destinations (e.g., virtual locations), user data (e.g., contacts, virtual object interaction history, context, etc.), UI elements (e.g., controls, display effects, visual affordances, etc.), or other visual and data objects that can be provided to run an XR environment, used by an application when executed on a particular runtime version. Additional details regarding storing and managing versions of an XR runtime are described herein with respect to block 502 of FIG. 5.

XR experience manager 436 can manage XR experiences from an application, e.g., stored in storage memory 418 or received from a network via 1/O 416. XR experience manager 436 can receive requests for XR experiences within an application. An XR experience can be any experience executable on an XR system as described herein, such as a virtual world experience, a gaming experience, a simulation experience, a work experience, a communication experience, a social experience, etc. Additional details regarding managing XR experiences in an XR system are described herein with respect to block 504 of FIG. 5.

Metadata retrieval module 438 can access metadata associated with a requested XR experience. The metadata can specify a set of versions, within a plurality of versions of the XR runtime, that are compatible with the XR experience. In some implementations, the metadata can be defined by a developer of the XR experience. In other cases, the metadata can be automatically generated based on an analysis of the features of the XR experience. For example, a mapping of XR experience features (e.g., function calls used, assets used, libraries included, etc.) can be mapped to data bundles or runtime versions and the needed data bundles can be selected to create a runtime version or an existing runtime version that supports all the XR experience features can be selected (e.g., by runtime version selector 440). It is contemplated that a “set” of versions can include any number of versions, including one version, or two or more versions. It is further contemplated that when two or more versions are included in the set of versions, the two or more versions can be contiguous or noncontiguous with respect to other versions in the set. Additional details regarding retrieval of metadata associated with an XR experience are described herein with respect to block 506 of FIG. 5.

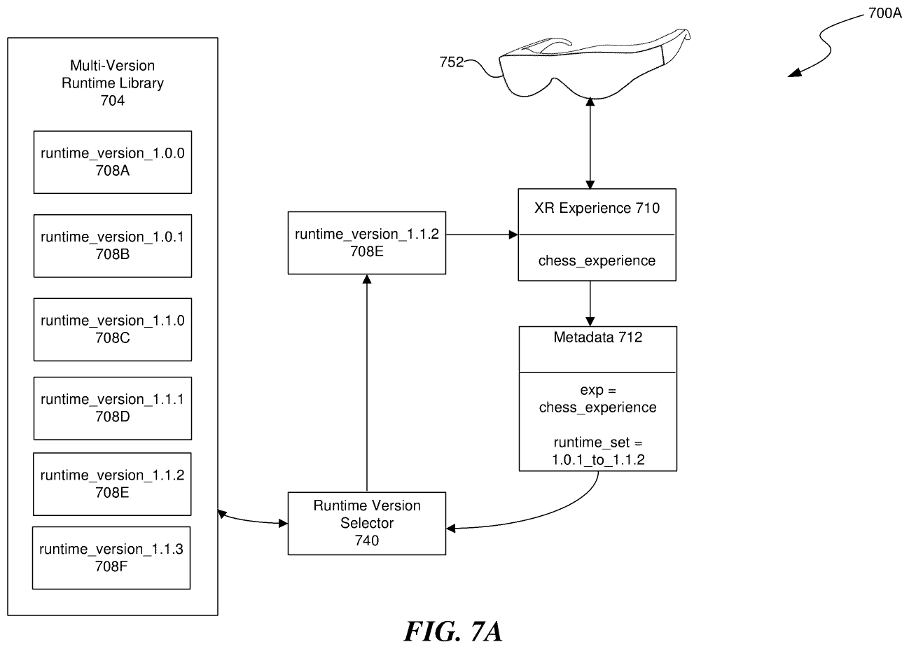

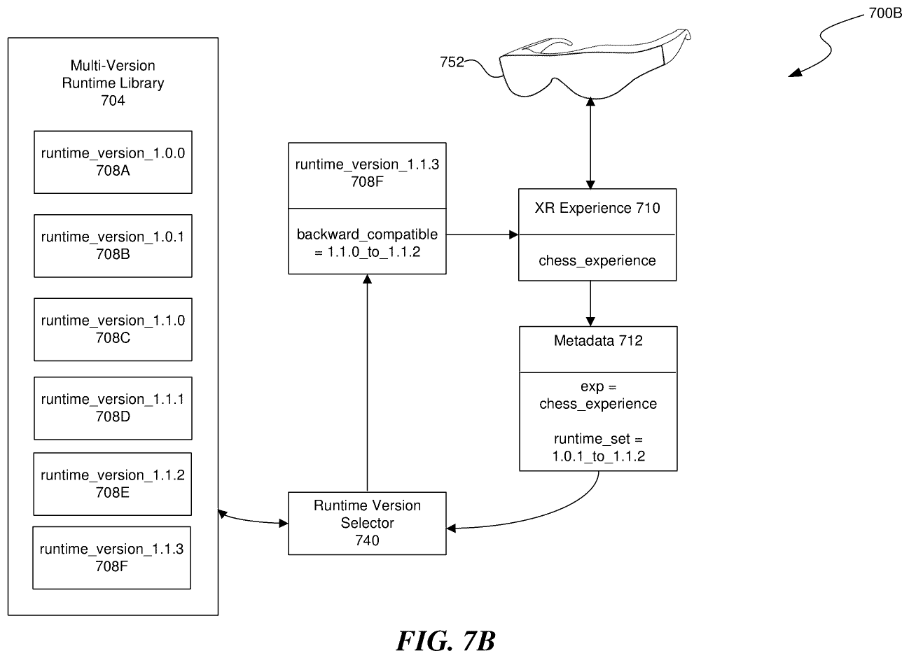

Runtime version selector 440 can select a version of the XR runtime. Runtime version selector 440 can select the version of the XR runtime that is either A) a latest version within the set of versions that are compatible with the XR experience (as described herein with respect to FIG. 7A), or B) a latest version outside the set of compatible versions that is within the plurality of versions and that is specified as being backward compatible with at least one version of the XR runtime within the set of compatible versions (as described herein with respect to FIG. 7B). Additional details regarding selection of a runtime version are described herein with respect to block 508 of FIG. 5.

XR experience loader 442 can load the XR experience by executing the application using the selected version of the XR runtime by accessing the scripts and assets from the set of data bundles specified for the selected version of the XR runtime. In some implementations, the scripts and assets can be specific to an XR environment, such as by defining virtual objects and interactions of the virtual objects with each other, with a user, within an environment, etc. Additional details regarding loading an XR experience are described herein with respect to block 510 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for managing updates for an XR system in cross-version and cross-platform environments. In some implementations, process 500 can be performed as a response to a user request for an XR experience within an application. In some implementations, process 500 can be performed on an XR device or by a server system configured to stream an XR experience to an XR device. Although illustrated as having only one iteration, it is contemplated that process 500 can be performed multiple times, repeatedly, consecutively, concurrently, in parallel, etc., as requests for XR experiences are received from one or more computing devices associated with a user.

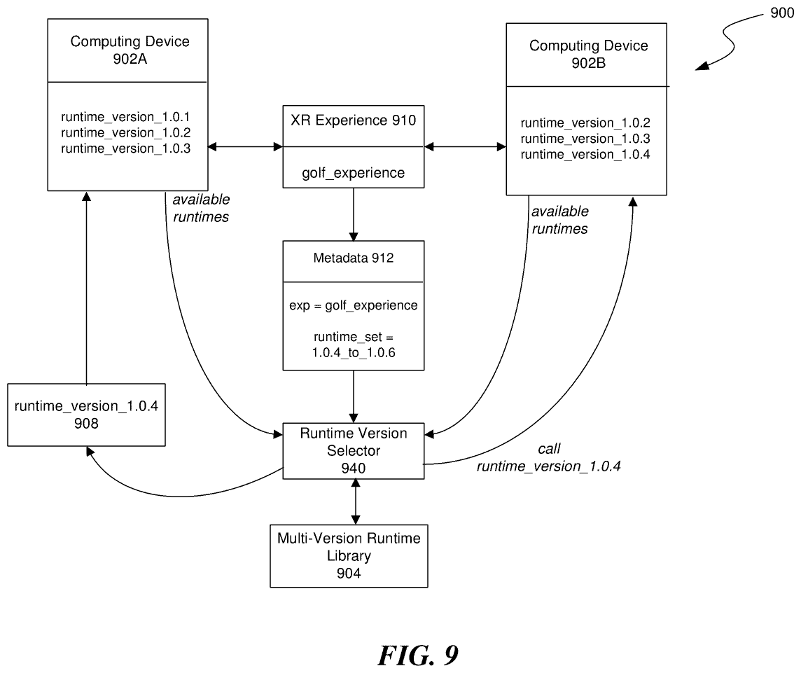

At block 502, process 500 can store a plurality of versions of an XR runtime. As appreciated by one skilled in the art, an XR runtime can be the environment in which an application is executed that provides the functionality needed for the application. The versions of the XR runtime can be stored locally and/or on a server and accessible over a network, or some versions can be stored locally and some on a server, such as is described further herein with respect to FIG. 9. Each version of the XR runtime can specify a set of data bundles including APIs, scripts, and assets that will be used when that version of the XR runtime is executed. In some implementations, the APIs, scripts, and assets can be specific to an XR environment. For example, the scripts can be configured to perform at least one of a) controlling physics of the XR experience, b) defining how virtual objects interact or are displayed in the XR experience, c) defining how user inputs are interpreted in the XR experience, d) providing environment context and analysis, e) providing interfaces to network systems and services (e.g., social media tie-ins, messaging, data providers, etc.), f) providing interfaces to find and interact with objects or other XR experiences, g) providing various analysis and machine learning services such as object recognition, user sentiment analysis, eye tracking, hand tracking, etc.) virtual assistant and voice services, etc. In some implementations, the assets can define virtual object representations in the XR experience, user data (e.g., contacts, virtual object interaction history, context, etc.), UI elements (e.g., controls, display effects, visual affordances, etc.), or other visual and data objects that can be provided to run an artificial reality environment. In some implementations, the virtual object representations can be two-dimensional or three-dimensional renderings overlaid onto a real-world or virtual environment, and can interact with the user and/or the environment according to the scripts defined by that version of the XR runtime.

In some implementations, process 500 can obtain an updated version of the XR runtime, and install the updated version of the XR runtime without uninstalling the plurality of stored versions of the XR runtime. For example, updating to a new version of a runtime can include storing the bundles for that runtime and specifying which of the existing and new bundles correspond to the runtime version. Thus, process 500 can build a library of versions of XR runtimes in which new versions of the XR runtime can be added without affecting the previous versions of the XR runtime. Thus, older versions of the XR runtime can remain and be available to load experiences potentially incompatible with the most recent version of the XR runtime.

At block 504, process 500 can receive a request for an XR experience within an application. An XR experience can be any experience executable by an XR system described herein. For example, an XR experience can be a virtual world experience, a gaming experience, a simulation experience, a work experience, a communication experience, a social experience, etc. In some implementations, an XR experience can be a fully immersive world while in other cases an XR experience can be a set of elements added to an existing world. The XR experience can be stored locally and/or on a server and accessible over a network. In some implementations, some XR experiences can be stored locally, while others are stored remotely. In some implementations, some components of the XR experiences can be stored locally, while others are stored remotely. For example, data bundles associated with executing an application on a particular version of an XR runtime can be stored remotely and pushed to a user device when an XR experience is requested.

At block 506, process 500, responsive to the request for the XR experience, can access metadata associated with the XR experience. The metadata can specify a set of versions, within the plurality of stored versions of the artificial reality runtime, that are compatible with the XR experience. It is contemplated that a “set” of versions can include any number of versions, including one version or two or more versions. It is further contemplated that when two or more versions are included in the set of versions, the two or more versions can be contiguous, or can be separate with other versions available between the versions of the set. In some implementations, the metadata can be defined by a developer of the XR experience. In other cases, the metadata can be automatically generated based on an analysis of the features of the XR experience. For example, a mapping of XR experience features (e.g., function calls used, assets used, libraries included, etc.) can be mapped to data bundles or runtime versions. As used herein, runtime compatibility with an XR experience can refer to the set of runtimes that can support the functionality of the particular XR experience.

At block 508, process 500 can select a version of the XR runtime. Process 500 can select the version of the XR runtime that is either A) a latest version within the set of compatible versions (as described further herein with respect to FIG. 7A), or B) a latest version outside the set of compatible versions, but within the plurality of stored versions, and that is specified as being backward compatible with at least one version of the XR runtime within the set of compatible versions (as described further herein with respect to FIG. 7B). In some implementations, XR runtime versions may not be explicitly defined and selecting an XR runtime version can include selecting the set of data bundles needed to execute the XR experience requested at block 504. In some implementations, the latest version of the XR runtime within the set of versions is not a most recent version of the XR runtime. In other words, the selected version of the XR runtime is not necessarily the most recent version of the XR runtime, and can be a previous version of the XR runtime that has not been replaced or uninstalled by a more recent version.

At block 510, process 500 can load the XR experience by executing the application using the selected version of the artificial reality runtime by accessing the scripts and assets from the set of data bundles specified for the selected version of the XR runtime. As described above, the scripts and assets can specify various objects and features specific to an XR environment and their interactions with a user and, in some implementations, the real-world or virtual environment. The data bundles including these scripts and assets can be specific to the selected version of the XR runtime, and thus can be different for different XR runtimes in loading the same XR experience.

In some implementations, process 500 can receive multiple requests for the XR experience from multiple computing devices, e.g., for a multiplayer XR experience. In such implementations, process 500 can obtain data indicative of available versions of the XR runtime from the requesting computing devices and determine, from the data, at least one overlapping version within the available versions that is available on all of the computing devices. Process 500 can then select a version of the XR runtime that is the latest version within the set of versions compatible with the XR experience and that is also within the at least one overlapping version.

In a multiplayer XR experience, it is also contemplated that one or more requesting computing devices may not have a version of the XR runtime compatible with the XR experience and/or two or more requesting computing devices may not have any overlapping versions. In such implementations, process 500 can, for example, select the latest version of the XR runtime compatible with the XR experience, and push the selected version (e.g., the needed data bundles) to the computing devices that do not have that version stored. In another example, process 500 can select the latest compatible version that the most number of requesting computing devices possess, and push that version to the computing devices that do not have that version stored.

In some implementations, process 500 can further determine the set of data bundles including scripts and assets that will be used when the selected version of the XR runtime is executed, and push that set of data bundles to the computing devices. In some implementations, process 500 can first determine whether the requesting computing devices have the necessary data bundles, and push only those scripts and assets needed by each computing device to that computing device. Because the data bundles can be different for an XR experience based on which XR runtime is executed, process 500 can push different data bundles to different computing devices for the same XR experience.

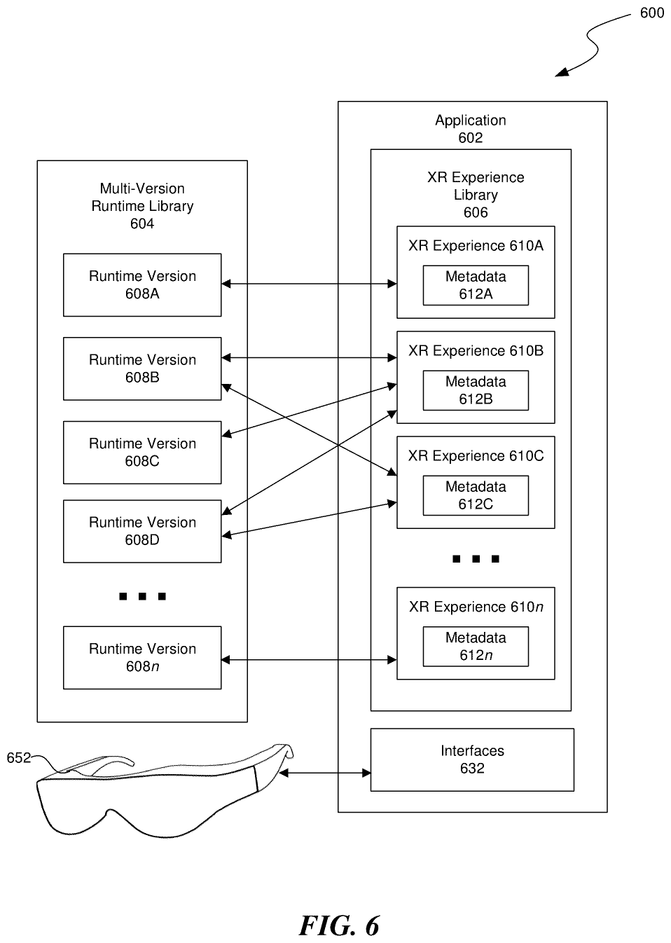

FIG. 6 is a block diagram illustrating a system 600 used in some implementations of the present technology for managing updates for an XR system in cross-version and cross-platform environments. System 600 can include application 602 in operable communication with multi-version runtime library 604. In some implementations, application 602 and multi-version runtime library 604 can be stored locally on a client device. In some implementations, application 602 and multi-version runtime library 604 can be stored at one or more servers and can be accessed over a network by a client device. In some implementations, application 602 can be stored locally on a client device and multi-version runtime library 604 can be stored on a server, or vice versa. In some implementations, one or more components of application 602 can be stored locally, while others are stored on a server.

Application 602 can include XR experience library 606. XR experience library 606 can store a plurality of XR experiences 610A-610n having metadata 612A-612n, respectively. Application 602 can be in operative communication with HMD 652 via interfaces 632. HMD 652 can be similar to HMD 200 of FIG. 2A or HMD 252 of FIG. 2B described herein. Multi-version runtime library 604 can include a plurality of runtime versions 608A-608n.

Metadata 612A-612n can each specify one or more runtime versions 608A-608n that are compatible with XR experiences 610A-610n, respectively. For example, metadata 612A can indicate that XR experience 610A is compatible with runtime version 608A; metadata 612B can indicate that XR experience 610B is compatible with runtime versions 608B-608D; metadata 612C can indicate that XR experience 610C is compatible with runtime versions 608B, 608D; and metadata 612n can indicate that XR experience 610n is compatible with runtime version 608n.

FIG. 7A is a conceptual diagram illustrating an exemplary system 700A used in some implementations for selecting the latest supported version of a runtime for an artificial reality experience. System 700A can include XR device 752, which can be, for example, HMD 200 of FIG. 2A or HMD 252 of FIG. 2B. System 700A can further include runtime version selector 740, which can be similar to runtime version selector 440 of FIG. 4. System 700A can further include multi-version runtime library 704, which can be similar to multi-version runtime library 604 of FIG. 6.

XR device 752 can request XR experience 710; in this example, “chess_experience”. XR experience 710 can be associated with metadata 712, which can identify a set of runtime versions (“runtime_set”) compatible with XR experience 710; in this example, a range of runtime versions between 1.0.1 to 1.1.2. Runtime version selector 740 can obtain metadata 712 and access multi-version runtime library 704.

Multi-version runtime library 704 can include a plurality of runtime versions 708A-708F. In this example, runtime version selector 740 can determine that runtime_version_1.0.1 708B, runtime_version_1.1.0 708C, runtime_version_1.1.1 708D, and runtime_version_1.1.2 708E are within runtime_set of metadata 712 and therefore compatible with XR experience 710. In this example, runtime version selector 740 can select the latest runtime version available within multi-version runtime library 704 and compatible with XR experience 710; in this case, runtime_version_1.1.2 708E. Runtime version selector 740 can further provide runtime_version_1.1.2 708E to XR experience 710 in order to load XR experience 710 on XR device 752.

FIG. 7B is a conceptual diagram illustrating an exemplary system 700B used in some implementations for selecting the latest version of a runtime that is backward compatible with a supported version of a runtime for an XR experience. In some instances, it may be desirable to use a later runtime version available to load XR experience 710, even though XR experience 710 may not be explicitly compatible with that runtime version. However, if the later runtime version is backward compatible with a runtime version within the set of runtimes compatible with XR experience 710, system 700B can nevertheless load XR experience 710 using the later runtime version without compatibility issues. This may be desirable in instances where older runtime versions are being phased out from usage to be uninstalled, for example.

System 700B can include XR device 752, runtime version selector 740, and multi-version runtime library 704. Runtime version selector 740 can be similar to runtime version selector 440 of FIG. 4. XR device 752 can request XR experience 710; in this example, “chess_experience”. XR experience 710 can be associated with metadata 712, which can identify a set of runtime versions (“runtime_set”) compatible with XR experience 710; in this example, a range of runtime versions between 1.0.1 to 1.1.2. Runtime version selector 740 can receive metadata 712 and access multi-version runtime library 704.

Multi-version runtime library 704 can include a plurality of runtime versions 708A-708F. In this example, runtime version selector 740 can determine that runtime_version_1.0.1 708B, runtime_version_1.1.0 708C, runtime_version_1.1.1 708D, and runtime_version_1.1.2 708E are within runtime_set of metadata 712 and therefore compatible with XR experience 710. In this example, runtime version selector 740 can select the latest version of runtime available within multi-version runtime library 704 that is backward compatible with XR experience 710; in this case, runtime_version_1.1.3 708F (which is backward compatible with runtime versions 1.1.0 to 1.1.2), and provide runtime_version_1.1.3 708F to XR experience 710 in order to load XR experience 710 on XR device 752.

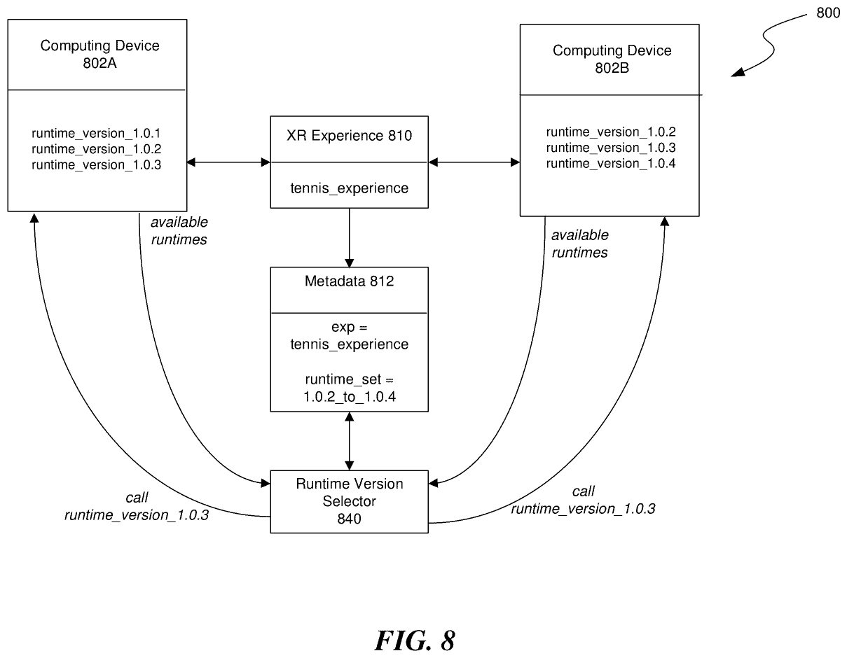

FIG. 8 is a conceptual diagram illustrating an exemplary system 800 used in some implementations for selecting the latest supported overlapping version of a runtime in a multiplayer artificial reality experience. In some implementations, system 800 can receive multiple requests for the XR experience from multiple computing devices, e.g., for a multiplayer XR experience. In such implementations, system 800 can obtain data indicative of available versions of the XR runtime from the requesting computing devices and determine, from the data, at least one overlapping version within the available versions that is available on all of the computing devices. System 800 can then select a version of the XR runtime that is the latest version within the set of versions compatible with the XR experience and that is also within the at least one overlapping version.

System 800 includes computing device 802A and computing device 802B associated with two respective users attempting to load XR experience 810; in this case, “tennis_experience”. It is contemplated that the components necessary to load XR experience 810 can be stored locally on computing devices 802A-B, can be stored on a server over a network, or some of the components can be stored locally while others are stored on a server. Although illustrated as two computing devices 802A-B, it is contemplated that any number of computing devices can attempt to access XR experience 810 in a multiplayer mode.

Computing device 802A and computing device 802B can have a plurality of runtime versions installed locally. Specifically, computing device 802A can have access to runtime_version_1.0.1, runtime_version_1.0.2, and runtime_version_1.0.0.3. Computing device 802B can have access to runtime_version_1.0.2, runtime_version_1.0.3, and runtime_version_1.0.4.

XR experience 810 is associated with metadata 812. Metadata 812 can specify the experience that computing devices 802A-B desire to load (i.e., “tennis_experience”), as well as the set of runtimes that are compatible with that experience (i.e., “runtime_set=1.0.2_to_1.0.4”). Runtime version selector 840 can obtain metadata 812 as well as the set of runtimes available on computing device 802A and computing device 802B. Runtime version selector 840 can be similar to runtime version selector 440 of FIG. 4, for example. Runtime version selector 840 can select the latest runtime version available on both computing devices 802A and 802B (i.e., the latest overlapping runtime version) that is also compatible with XR experience 810, i.e., within runtime_set 1.0.2 to 1.0.4. In this case, runtime version selector 840 can select runtime_version_1.0.3. Runtime version selector 840 can call runtime_version_1.0.3 on computing device 802A and computing device 802B in order to load XR experience 810.

FIG. 9 is a conceptual diagram illustrating an exemplary system 900 used in some implementations for selecting and pushing the latest supported version of a runtime in a multiplayer XR experience. In a multiplayer XR experience, it is also contemplated that one or more requesting computing devices may not have a version of the XR runtime compatible with the XR experience and/or that two or more requesting computing devices may not have any overlapping versions. In such implementations, system 900 can, for example, select the latest version of the XR runtime compatible with the XR experience, and push the selected version to the computing devices that do not have that version stored.

System 900 includes computing device 902A and computing device 902B associated with two respective users attempting to load XR experience 910; in this case, “golf_experience”. It is contemplated that the components necessary to load XR experience 910 can be stored locally on computing devices 902A-B, can be stored on a server over a network, or some of the components can be stored locally while others are stored on a server. System 900 further includes runtime version selector 940, which can be similar to runtime version selector 440 of FIG. 4.

Computing device 902A and computing device 902B can have a plurality of runtime versions installed locally. Specifically, computing device 902A can have access to runtime_version_1.0.1, runtime_version_1.0.2, and runtime_version_1.0.3. Computing device 902B can have access to runtime_version_1.0.2, runtime_version_1.0.3, and runtime_version_1.0.4.

XR experience 910 is associated with metadata 912. Metadata 912 can specify the experience that computing devices 802A-B desire to load (i.e., “golf_experience”), as well as the set of runtimes that are compatible with that experience (i.e., “runtime_set=1.0.4_to_1.0.6”). Runtime version selector 940 can obtain metadata 912 as well as the set of runtime versions available on computing device 902A and computing device 902B. In this case, computing device 902A and computing device 902B do not have any overlapping runtimes that are compatible with XR experience 910. Thus, runtime version selector 940 can select the latest version of the runtime compatible with XR experience 810 that is available on at least one of computing device 902A and computing device 902B; in this case, runtime_version_1.0.4.

Runtime version selector 940 can access multi-version runtime library 904 to obtain runtime_version_1.0.4, and push runtime_version_1.0.4 to computing device 902A in order for computing device 902A to load XR experience 910. Runtime version selector 940 can call runtime_version_1.0.4 on computing device 902B in order to load XR experience 910 on computing device 902B.

Although illustrated as two computing devices 902A-B, it is contemplated that any number of computing devices can attempt to access XR experience 910 in a multiplayer mode. For example, in some embodiments, where more than two computing devices access XR experience 910, system 900 can select the latest compatible version of the XR runtime that the most number of requesting computing devices possess, and push that version to the computing devices that do not have that version stored.

It is contemplated that the implementations described in FIGS. 7A-9 can be modified in any suitable manner, such as by combining the implementation described in FIG. 7B with the multiplayer modes of FIGS. 8 and/or 9. For example, it is contemplated that, in some implementations, system 800 and/or system 900 can select a later version of the runtime outside of the compatible runtimes that is backward compatible with the compatible runtimes, and call and/or push that version of the runtime to the computing devices.

In some implementations, it is contemplated that one or more components of systems 700A, 700B, 800, and/or 900 can be stored on a user (i.e., client) device, remotely on a server, or combinations thereof. For example, it is contemplated that system 700A and 700B can be implemented entirely locally, or that runtime version selector 740 and/or multi-version runtime library 704 can be implemented remotely. With respect to FIG. 8, it is contemplated that the various runtime versions can be stored locally; the XR experience 810 can be stored locally or remotely; and the runtime version selector 840 can be stored locally or remotely. With respect to FIG. 9, it is contemplated that the various runtime versions can be stored locally; the XR experience 910 can be stored locally or remotely; the runtime version selector 940 can be stored locally or remotely; and the multi-version runtime library 904 can be stored remotely.

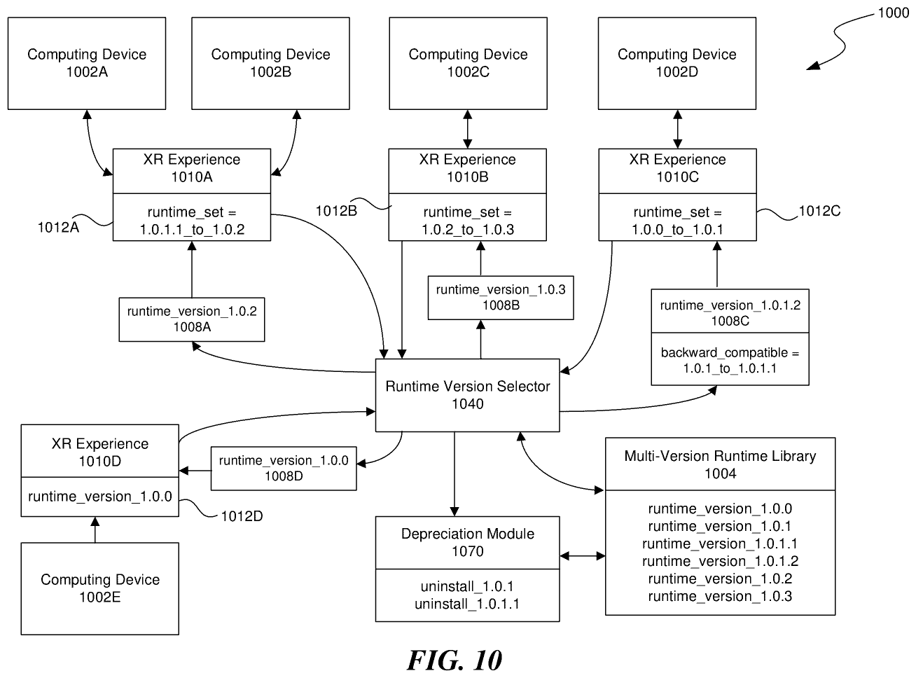

FIG. 10 is a conceptual diagram illustrating an exemplary system 1000 used in some implementations for selecting and uninstalling unused versions of a runtime. According to some implementations, system 1000 can phase out older and/or unused versions of runtime versions, thereby explicitly removing access to them. System 1000 includes a plurality of computing devices 1002A-E requesting to load a plurality of XR experiences 1010A-D. Specifically, computing devices 1002A-B can request to load XR experience 1010A; computing device 1002C can request to load XR experience 1010B; computing device 1002D can request to load XR experience 1010C; and computing device 1002E can request to load XR experience 1010D. It is contemplated that any number of computing devices can request any number of XR experiences simultaneously or consecutively over any period of time within the purview of FIG. 10.

XR experiences 1010A-D can be associated with metadata 1012A-D, respectively. Metadata 1012A can specify compatible runtimes for XR experience 1010A, i.e., 1.0.1.1 to 1.0.2; metadata 1012B can specify compatible runtimes for XR experience 1010B, i.e., 1.0.2 to 1.0.3; metadata 1012C can specify compatible runtimes for XR experience 1010C, i.e., 1.0.0 to 1.0.1; and metadata 1012D can specify compatible runtimes for XR experience 1010D, i.e., 1.0.0.

Using the processes described herein with respect to FIGS. 7A-9, runtime version selector 1040 (which can be similar to runtime version selector 440 of FIG. 4, runtime version selector 740 of FIGS. 7A-B, runtime version selector 840 of FIG. 8, and/or runtime version selector 940 of FIG. 9) can select, call, obtain, and/or push the appropriate runtime versions to computing devices 1002A-E. In this example, runtime version selector can call and/or push runtime_version_1.0.2 1008A to load XR experience 1010A; runtime_version_1.0.3 to load XR experience 1010B; runtime_version_1.0.1.2 1008C, which is backward compatible with runtime versions 1.0.1 to 1.0.1.1, to load XR experience 1010C; and runtime_version_1.0.0 1008D to load XR experience 1010D.

Runtime version selector 1040 can determine, e.g., based on a log of runtime executions, that runtime_version_1.0.1 and runtime_version_1.0.1.1 have not been needed to load XR experiences 1010A-D. Thus, runtime version selector 1040 can direct depreciation module 1070 to uninstall runtime_version_1.0.1 and runtime_version_1.0.1.1 from multi-version runtime library 1004, explicitly removing access to those runtime versions by computing devices 1002A-E as they are no longer needed. It is contemplated, however, that if one or more of computing devices 1002A-E need to access those runtime versions in the future without available backward compatible alternatives, such runtime versions can be reinstalled. In various implementations, which runtime versions (or individual data bundles) to uninstall can be based on various factors such as: which runtimes or bundles have not been used on the current XR device for a threshold time, which runtimes or bundles have not been used across a set of XR devices (e.g., in a geographical area, on devices owned by users identified as similar to the current user, across all XR devices that provide runtime execution logs, etc.) for a threshold time, according to explicit selections of outdated runtimes (e.g., when a security vulnerability is detected or a corresponding user experience provided by a runtime version is determined to be unwanted), etc.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for managing updates, for an artificial reality system, in cross-version and cross-platform environments, the method comprising:
storing a plurality of versions of an artificial reality runtime, wherein each version of the artificial reality runtime specifies a set of data bundles including scripts and assets that will be used when that version of the artificial reality runtime is executed;
receiving a request for an artificial reality experience within an application;
in response to the request, accessing metadata associated with the artificial reality experience, the metadata specifying a set of versions, within the plurality of versions of the artificial reality runtime, that are compatible with the artificial reality experience;
selecting a version of the artificial reality runtime that is either A) a latest version within the set of versions or B) a latest version outside the set of versions, within the plurality of versions, and specified as being backward compatible with at least one version of the artificial reality runtime within the set of versions; and
loading the artificial reality experience by executing the application using the selected version of the artificial reality runtime by accessing the scripts and assets from the set of data bundles specified for the selected version of the artificial reality runtime.

2. The method of claim 1, further comprising:
obtaining an updated version of the artificial reality runtime; and
installing the updated version of the artificial reality runtime without uninstalling the plurality of versions of the artificial reality runtime.

3. The method of claim 1, wherein the latest version of the artificial reality runtime, within the set of versions, is not a most recent version of the artificial reality runtime.

4. The method of claim 1, wherein the request is a first request received from a first computing device, and wherein the method further comprises:
receiving a second request for the artificial reality experience in the application from a second computing device;
obtaining data indicative of available versions of the artificial reality runtime within the plurality of versions from the first computing device and the second computing device; and
determining, from the data, at least one overlapping version within the available versions that is available on both the first computing device and the second computing device,
wherein the selected version of the artificial reality runtime is the latest version within the set of versions and within the at least one overlapping version.

5. The method of claim 1, wherein the request is a first request received from a first computing device, and wherein the method further comprises:
receiving a second request for the artificial reality experience in the application from a second computing device;
obtaining data indicative of available versions of the artificial reality runtime within the plurality of versions from the second computing device;
determining, from the data, that the selected version of the artificial reality runtime is not stored on the second computing device;
determining the set of data bundles including scripts and assets that will be used when the selected version of the artificial reality runtime is executed; and
pushing, to the second computing device, the selected version of the artificial reality runtime and the set of data bundles that will be used when the selected version of the artificial reality runtime is executed.

6. The method of claim 1, wherein at least some of the scripts are configured to perform at least one of a) controlling physics of the artificial reality experience, b) defining how virtual objects interact in the artificial reality experience, c) defining how user inputs are interpreted in the artificial reality experience, or any combination thereof.

7. The method of claim 1, wherein at least some of the assets define virtual object representations in the artificial reality experience.

8. A computer-readable storage medium storing instructions that, when executed by a computing system, cause the computing system to perform a process for managing updates, for an artificial reality system, in cross-version and cross-platform environments, the process comprising:
storing a plurality of versions of an artificial reality runtime, wherein each version of the artificial reality runtime specifies a set of data bundles including scripts and assets that will be used when that version of the artificial reality runtime is executed;
receiving a request for an artificial reality experience within an application;
in response to the request, accessing metadata associated with the artificial reality experience, the metadata specifying a set of versions, within the plurality of versions of the artificial reality runtime, that are compatible with the artificial reality experience;
selecting a version of the artificial reality runtime that is either A) a latest version within the set of versions or B) a latest version outside the set of versions, within the plurality of versions, and specified as being backward compatible with at least one version of the artificial reality runtime within the set of versions; and
loading the artificial reality experience by executing the application using the selected version of the artificial reality runtime by accessing the scripts and assets from the set of data bundles specified for the selected version of the artificial reality runtime.

9. The computer-readable storage medium of claim 8, the process further comprising:
obtaining an updated version of the artificial reality runtime associated with the application; and
installing the updated version of the artificial reality runtime without uninstalling the plurality of versions of the artificial reality runtime.

10. The computer-readable storage medium of claim 8, wherein the latest version of the artificial reality runtime within the set of versions is not a most recent version of the artificial reality runtime.

11. The computer-readable storage medium of claim 8, wherein the request is a first request received from a first computing device, and wherein the process further comprises:
receiving a second request for the artificial reality experience in the application from a second computing device;
obtaining data indicative of available versions of the artificial reality runtime within the plurality of versions from the first computing device and the second computing device; and
determining, from the data, at least one overlapping version within the available versions that is available on both the first computing device and the second computing device,
wherein the selected version of the artificial reality runtime is the latest version within the set of versions and within the at least one overlapping version.

12. The computer-readable storage medium of claim 8, wherein the request is a first request received from a first computing device, and wherein the process further comprises:
receiving a second request for the artificial reality experience in the application from a second computing device;
obtaining data indicative of available versions of the artificial reality runtime within the plurality of versions from the second computing device;
determining, from the data, that the selected version of the artificial reality runtime is not stored on the second computing device;
determining the set of data bundles including scripts and assets that will be used when the selected version of the artificial reality runtime is executed; and
pushing, to the second computing device, the selected version of the artificial reality runtime and the set of data bundles that will be used when the selected version of the artificial reality runtime is executed.

13. The computer-readable storage medium of claim 8, wherein at least some of the scripts are configured to perform at least one of a) controlling physics of the artificial reality experience, b) defining how virtual objects interact in the artificial reality experience, c) defining how user inputs are interpreted in the artificial reality experience, or any combination thereof.

14. The computer-readable storage medium of claim 8, wherein at least some of the assets define virtual object representations in the artificial reality experience.

15. A computing system for managing updates, for an artificial reality system, in cross-version and cross-platform environments, the computing system comprising:
one or more processors; and
one or more memories storing instructions that, when executed by the one or more processors, cause the computing system to perform a process comprising:
storing a plurality of versions of an artificial reality runtime;
receiving a request for an artificial reality experience within an application;
in response to the request, determining a set of versions, within the plurality of versions, that are compatible with the artificial reality experience;
selecting a version of the artificial reality runtime that is either A) a latest version within the set of versions or B) a latest version outside the set of versions specified as being backward compatible with a version of the artificial reality runtime within the set of versions; and
loading the artificial reality experience by executing the application using the selected version of the artificial reality runtime.

16. The computing system of claim 15, the process further comprising:
obtaining an updated version of the artificial reality runtime associated with the application; and
installing the updated version of the artificial reality runtime without uninstalling the plurality of versions of the artificial reality runtime.

17. The computing system of claim 15, wherein the request is a first request received from a first computing device, and wherein the process further comprises:
receiving a second request for the artificial reality experience in the application from a second computing device;
obtaining data indicative of available versions of the artificial reality runtime within the plurality of versions from the first computing device and the second computing device; and
determining, from the data, at least one overlapping version within the available versions that is available on both the first computing device and the second computing device,
wherein the selected version of the artificial reality runtime is the latest version within the set of versions and within the at least one overlapping version.

18. The computing system of claim 15, wherein the request is a first request received from a first computing device, and wherein the process further comprises:
receiving a second request for the artificial reality experience in the application from a second computing device;
obtaining data indicative of available versions of the artificial reality runtime within the plurality of versions from the second computing device;
determining, from the data, that the selected version of the artificial reality runtime is not stored on the second computing device;
determining a set of data bundles including scripts and assets that will be used when the selected version of the artificial reality runtime is executed; and
pushing, to the second computing device, the selected version of the artificial reality runtime and the set of data bundles that will be used when the selected version of the artificial reality runtime is executed.

19. The computing system of claim 15,
wherein each version of the artificial reality runtime specifies a set of data bundles including scripts and assets that will be used when that version of the artificial reality runtime is executed, and
wherein at least some of the scripts are configured to perform at least one of a) controlling physics of the artificial reality experience, b) defining how virtual objects interact in the artificial reality experience, c) defining how user inputs are interpreted in the artificial reality experience, or any combination thereof.

20. The computing system of claim 15,
wherein each version of the artificial reality runtime specifies a set of data bundles including scripts and assets that will be used when that version of the artificial reality runtime is executed, and
wherein at least some of the assets define virtual object representations in the artificial reality experience.
